(19) United States
(12) Patent Application Publication
(10) Pub. No.: US 2023/0160527 A1
(43) Pub. Date: May 25, 2023

(54) USE OF A FIBER COMPOSITE MATERIAL CONNECTING SECTION FOR CONNECTING A TUBULAR FIBER COMPOSITE MATERIAL STRUCTURE TO A CONNECTOR DEVICE

(71) Applicants: Leibniz-Institut Fuer Verbundwerkstoffe GmbH, Kaiserslautern (DE); Hochschule Kaiserslautern, Kaiserslautern (DE)

(72) Inventors: Uwe SCHMITT, Kaiserslautern (DE); Thomas PFAFF, Bruchmuehlbach-Miesau (DE); Michael MAGIN, Lebach (DE)

(73) Assignees: Leibniz-Institut Fuer Verbundwerkstoffe GmbH, Kaiserslautern (DE); Hochschule Kaiserslautern, Kaiserslautern (DE)

(21) Appl. No.: 17/921,652

(22) PCT Filed: May 5, 2021
(86) PCT No.: PCT/DE2021/100406

§ 371 Date: Oct. 27, 2022

(30) Foreign Application Priority Data
May 6, 2020 (DE) 10 2020 112 179.2

(51) Int. Cl. F17C 1/16

(52) U.S. Cl. CPC F17C 1/16; F17C 2203/0604; F17C 2203/0631; F17C 2203/0673; F17C 2205/0142; F17C 2205/0311

(57) ABSTRACT

Use of a fiber composite material connecting portion to connect a tubular fiber composite material structure to a connecting device, wherein the connecting portion has at least one fiber deflecting element in its interior, wherein the course of the long fibers from the fiber composite material component follows the shape of a fiber deflecting portion of a fiber deflecting element, so that the fiber direction thereof is deflected at the fiber deflecting portion, and wherein the long fibers do not completely loop around the fiber deflecting elements with which they are associated respectively, wherein the fiber deflecting elements consist of fiber composite material, for a pressure tank.

### CROSS REFERENCE TO RELATED APPLICATIONS

This application is the National Stage of PCT/DE2021/100406 filed on May 5, 2021, which claims priority under 35 U.S.C. §119 of German Application No. 10 2020 112 179.2 filed on May 6, 2020, the disclosure of which is incorporated by reference. The international application under PCT article 21(2) was not published in English.

### BACKGROUND OF THE INVENTION

### 1. Field of the Invention

The present invention relates to the use of a fiber composite material connecting portion to connect a tubular fiber composite material structure to a connecting device, wherein the fiber composite material structure has more circumferential layers than longitudinal threads, wherein the connecting portion has at least one fiber deflecting element in its interior, wherein the course of the longitudinal threads from the fiber composite material component follows the shape of a fiber deflecting portion of a fiber deflecting element so that the fiber direction thereof is deflected at the fiber deflecting portion, and wherein the long fibers do not completely loop around the fiber deflecting elements with which they are associated respectively, wherein the fiber deflecting elements consist of fiber composite material, for a pressure tank.

### 2. Description of the Related Art

To connect fiber composite materials to components, the connection methods known for metal materials often cannot be used or can only be used with a loss of strength of the connection. In particular, the strength of the connection between the fiber composite material and the component is reduced by separation and breaking of fibers of the fiber composite material. Such breaks of the fibers occur, for example, when drilling through or trimming the fiber composite material in order to insert the component to be connected through the drilled hole or to glue it to the trimmed edges.

Therefore, fiber composite material connecting portions that connect a fiber composite material structure to a connecting device without severing the long fibers of the fiber composite structure are known.

WO 2016/008858 A1 describes a fiber composite material connecting portion for connecting a fiber composite material structure to a connecting device. The connecting portion in that case has at least one fiber deflecting element in its interior, wherein the course of first long fibers from the fiber composite material component follows the shape of a first fiber deflecting element, so that the fiber direction thereof is deflected at the first fiber deflecting portion. The course of second long fibers from the fiber composite material structure follows a second portion thereof or a second fiber deflecting element so that their fiber direction is deflected at the second fiber deflecting portion. The two fiber deflecting portions are spatially separated from each other, wherein a first securing projection and a second securing projection spatially separated from the first one are formed at the connecting portion in each case to transmit force into the connecting portion, and wherein the first securing projection is formed by the first fiber deflecting element and the first long fibers and the second securing projection is formed by the second fiber deflecting element and the second long fibers. The long fibers running from the fiber composite structure or the fiber composite material component to the securing portion are divided and distributed among a plurality of securing projections. This allows the tensile and compressive forces transmitted to the long fibers to be transmitted to another component. In this case, the fiber composite material component can be formed as a rod or tube as a tension-compression element. In particular, a large proportion of fibers with fiber direction in the longitudinal direction of the rod or tube can be provided.

EP 0 082 021 A2 describes the fastening of a ring, in particular a metal ring, on an object, which has walls or skirts made of fiber-reinforced synthetic resin material. The ring has a plurality of outer grooves. The skirt includes, for each groove, subsequently a first and a second layer of fiber-reinforced resin material. The fibers in the first layer are substantially oriented parallel to the axis of the ring an extend from the skirt into the respective grooves. A second layer is located above the first layer, which second layer consists of annular windings, which extend from the skirt in the direction of the groove. The second layer is at least partially located in the groove for fixing the first layer in the groove. This layering is repeated for each groove, and finally, subsequent hoop windings are wound over the entire product.

### SUMMARY OF THE INVENTION

The object of the invention is to create profoundly pressure-resistant pressure tanks.

The object is achieved by the use of a fiber composite material connecting portion to connect a tubular fiber composite material structure to a connecting device, wherein the fiber composite material structure has more circumferential layers than longitudinal threads, wherein the connecting portion has at least one fiber deflecting element in its interior, wherein the course of the long fibers from the fiber composite material component follows the shape of a fiber deflecting portion of a fiber deflecting element so that the fiber direction thereof is deflected at the fiber deflecting portion, and wherein the long fibers do not completely loop around the fiber deflecting elements with which they are associated respectively, wherein the fiber deflecting elements consist of fiber composite material, and wherein no firm connection is present between the tubular fiber composite material structure and the connecting device, for a pressure tank.

The pressure tank can be configured as an inner and outer pressure tank. In this case, the pressure tank consists of the tubular fiber composite material structure, which is connected to a connecting device via the fiber composite material connecting portion. To connect the fiber composite material structure to the connecting device, the long fibers from the fiber composite material structure can run along a surface portion of the fiber deflecting elements. There is no need here for the long fibers to wrap around the fiber deflecting elements. The surface portion at least partially forms an outer surface of the connecting portion. The surface portions run at an angle of between 20° and 60°, particularly preferably 45°, from the direction of the long fibers running towards the connecting portion. The long fibers also run with a portion on the adjacent fiber deflecting elements, wherein the portions on the adjacent fiber deflecting elements change direction. After the change in direction, they run along the surfaces of the fiber deflecting elements. Due to the changed fiber direction, the outer surfaces of the fiber deflecting elements can be understood as fiber deflecting portions for the fibers. With regard to the long fibers, due to the curved surface along which the fibers run, the adjacent fiber deflecting elements also each fulfil the function of a fiber deflecting portion.

The fiber deflecting elements can each have a protruding tip in the direction of the connecting device. The long fibers reach here maximally to this tip, so that the long fibers do not completely wrap around the fiber deflecting element. The long fibers do not significantly change direction again after being deflected onto the fiber deflecting element. The surfaces of the fiber deflecting elements along which the long fibers run are planar at least in a portion into the vicinity of the tips and merge, after a deflection of preferably 90°, into a further surface each, said further surfaces running from the tips in the direction of the interior of the connecting portion. At the end of this surface there is in each case a notch, after which the outer surface of the connecting portion continues in the next fiber deflecting element, as far as it is not the last fiber deflecting element. The two surfaces that touch at the tip preferably form the legs of an equilateral triangle. They form a V-shaped depression of the connecting device.

The long fibers each preferably belong to a separate fiber layer. The long fibers can be embedded here in the outer surfaces of the fiber deflecting elements.

Advantageously, the use of tubular fiber composite material structures achieves a weight and cost reduction compared to conventional metal, but also conventionally wound fiber composite material pressure tanks (type 4). This weight and cost reduction is particularly advantageous in the field of H₂ high-pressure tanks in mobile applications such as motor vehicles, ships, aircraft and space travel.

The fiber deflecting elements can be configured as independent fiber deflecting elements. Alternatively, the fiber deflecting elements can be configured as a helical, interrelated fiber deflecting element.

Advantageously, in the present invention, smaller diameters of the tubular fiber composite material structure for the pressure tank can be achieved. In this way, the pressure tanks can have diameters < 100 mm. For example, for H₂ high-pressure tanks conventionally produced by the winding process, the minimum diameter is determined by the boss part. If this is 100 mm, the outer diameter of the pressure tank cannot be less than approximately 130 mm, since pressure tanks produced in the winding process require a boss part wound with fibers to absorb the longitudinal forces caused by the overpressure. Thus, in addition to the cylindrical portion with internal thread provided to accommodate the safety valve, the boss part must have a pronounced plate-shaped portion of larger diameter, which ultimately serves as a turning zone during winding and additionally absorbs the longitudinal forces caused by the internal pressure. This function of absorbing the longitudinal forces during the transition of the load from the cylindrical composite material region into the often metal dome region is achieved by the present invention in a much more compact manner and with lower stress concentrations.

Advantageously, the tubular fiber composite material structures with the connecting device can be loaded by both internal and external pressure compared to conventionally wound inner pressure tanks. This means that these tubular fiber composite material structures with connecting device are also suitable for use as nested high-pressure tanks, wherein the inner tank can also have a lower internal pressure than the outer tank and thus effectively represents a tank loaded by external pressure. As a rule, these high-pressure tanks have a minimum burst pressure of approximately 1575 bar.

Advantageously, the fiber composite material structure and the connecting device can be connected without adhesive bonding. The force transmission of tensile and compressive forces takes place by way of a form fit between the connecting device and the deflecting elements and the long fibers of the fiber composite material structure. This means that there is no tension in the event of temperature changes. Advantageously, no fibers are broken to secure the connecting device. Such a breaking of fibers can have a negative effect on the strength of the fiber composite material structure. Due to the lack of penetration by connecting elements such as bolts or screws, there is also no stress corrosion. The use of different materials with different temperature expansion coefficients does not lead to tension in the introduction of force between the tubular fiber composite material structure and the connecting device, not even as a result of large temperature differences, because there is no fixed connection, such as with an adhesive bond. For this reason, the pressure tank is also suitable for cryogenic applications, for example cryogenic high-pressure storage. For example, the pressure tank can be configured as a double-walled tank with a cryogenic inner tank, for example for liquid H₂, and gaseous H₂ in the outer tank. Cryogenic tanks are usually protected by way of very complex vacuum insulation layers against heating of the cryogenic contents. If the cryogenic content, for example H₂, becomes warmer than 20 K, part of the content must be blown off in order to cool down the remaining content. This blow-off could then pass from the inner to the outer tank in the case of a double-walled outer pressure/inner pressure tank and could continue to be available there as gaseous H₂.

Due to the larger number of circumferential layers of the tubular fiber composite material structure, these can be loaded with a higher internal as well as external pressure. Advantageously, the forces occurring in the cylindrical part of the tank due to the internal or external pressure are absorbed in particular by the circumferential layers. As a result, high-pressure tanks with a burst pressure of, for example, 1575 bar can be produced with the tubular fiber composite material structure. The overall laminate of the tubular fiber composite material structure particularly preferably has twice as many circumferential layers as longitudinal threads.

It is expedient here that the fiber composite material of the fiber deflecting elements mainly consists of circumferential layers.

Preferably, the V-shaped depressions of the connecting device are filled with circumferential layers of fiber composite material. Preferably, the circumferential layers are wound over the entire connecting device in the case of use as a pressure tank, more specifically preferably approximately in the ratio of ⅔ (circumferential layer) to ⅓ (longitudinal layer) with regard to the total wall thickness. The winding of the circumferential layers fixes the long fibers of the tubular fiber composite material structure to the connecting device.

Due to the orientation of the fibers of the fiber deflecting elements in the circumferential direction, tensile, compressive, and torsional forces, which are transmitted to the fiber deflecting elements via the long fibers of the fiber composite material structure, are converted into circumferential forces in the fibers of the fiber deflecting elements on the connecting portion. This allows an advantageous introduction of the forces into the fiber deflecting elements.

Another embodiment of the invention is that the connecting device comprises a dome cap.

The dome cap forms the pressure-resistant closure of a tubular fiber composite material structure. Such a tubular fiber composite material structure with a dome cap is advantageously suitable as a pressure tank. The forces acting on the fiber composite material structure due to the internal or external pressure can be transmitted via the long fibers and the fiber deflecting elements to the connecting device with the dome caps.

In another embodiment of the invention, the fiber composite material structure comprises a liner.

In order to ensure the tightness of the pressure tanks made of tubular fiber composite material structures against the escape or entry of media, for example H₂ from the outside, the tubular fiber composite material structures and the connecting device can be provided with a liner. This liner can be applied to the inside or outside of the tubular fiber composite material structures, depending on the direction of pressure. The liner can be a thermoplastic liner, for example HDPE or PA. It can also be made of glass, silicone, or metals. Advantageously, the liner ensures the media tightness of the fiber composite material structure even if intermediate fiber breaks occur in the fiber composite material structure.

An inner liner in combination with the dome caps can form the blank for the manufacture of an inner pressure tank. In this way, an additional core is avoided during manufacture. The liner, which is later connected to the dome caps in a media-tight manner, can be pressurized in the course of manufacture to serve as a core for the winding of the tubular fiber composite material structure. The level of pressure can be adapted here to the relevant requirements. Additional stabilization of the blank (liner and dome caps) during manufacture can be achieved by flooding the liner with a stabilizing medium (polystyrene, sand, hollow spheres, etc.) until the textile structure of the tank is stable.

Another embodiment of the invention is that a plurality of tubular fiber composite material structures are interconnected via the connecting devices.

This results in a structure with a plurality of pressure tanks. The connecting devices can be formed here as connectors between the pressure tanks. The structure formed from modular tank units can be used to make better use of installation space, for example in H₂ pressure tanks in vehicle construction. The modular pressure tanks can be oriented here in various arrangements. For example, a plurality of pressure tanks can be arranged in parallel next to each other. Alternatively, for example, a plurality of pressure tanks with liquid H₂ can be arranged in a pressure tank with gaseous H₂.

According to another embodiment of the invention, it is provided that the liner, depending on the pressure direction, is applied to the tubular fiber composite material structure inside or outside.

One embodiment of the invention is such that the liner serves as a core for the winding of the tubular fiber composite material structure.

Lastly, it is within the scope of the invention that a plurality of tubular fiber composite material structures are interconnected and combined in the form of sub-assemblies.

### BRIEF DESCRIPTION OF THE DRAWINGS

In the following, embodiments of the device for use according to the invention are explained in greater detail with reference to drawings.

In the drawings

FIG. 1 shows a fiber composite material connecting portion for use according to the invention in cross-section,

FIG. 2 shows a further fiber composite material connecting portion for use according to the invention in cross-section,

FIG. 3 shows a further cross-section of the fiber composite material connecting portion for use according to the invention as shown in FIG. 2,

FIG. 4 shows another fiber composite material connecting portion for use according to the invention in cross-section,

FIG. 5 shows a further fiber composite material connecting portion for use according to the invention in cross-section,

FIG. 6 shows a further fiber composite material connecting portion for use according to the invention in cross-section,

FIG. 7 shows a further fiber composite material connecting portion for use according to the invention in perspective cross-section,

FIG. 8 shows a perspective view of an arrangement of pressure tanks with the fiber composite material connecting portion according to the invention,

FIG. 9 shows a perspective view of a further arrangement of pressure tanks with the fiber composite material connecting portion according to the invention, and

FIG. 10 shows a perspective cross-section of a further arrangement of pressure tanks with the fiber composite material connecting portion according to the invention.

### DETAILED DESCRIPTION OF THE PREFERRED EMBODIMENTS

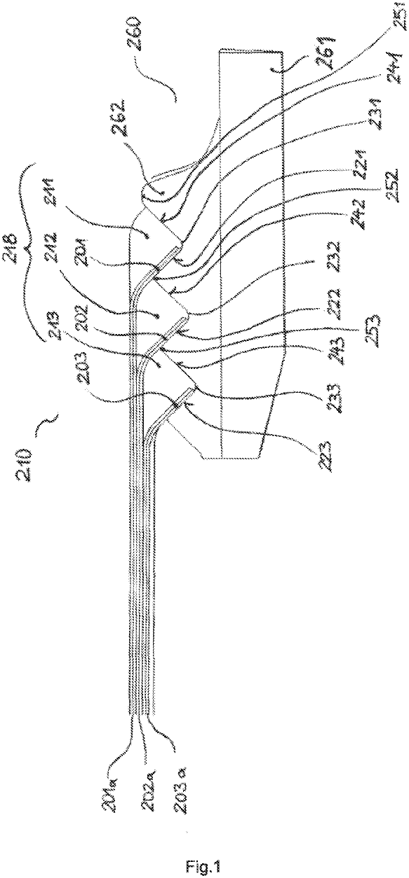

FIG. 1 shows a cross-sectional view through a portion of an embodiment of the connecting portion 210 in engagement with a matching connecting device 260. The connecting portion, particularly if it is tubular, can have another portion in the same cross-sectional plane. Preferably, this embodiment and those described below are used in a tubular connecting portion 210. In this embodiment, the long fibers 201a, 202a and 203a do not completely loop around the fiber deflecting elements 211, 212 and 213 with which they are associated, respectively. Rather, the long fibers 201a, 202a and 203a run along a surface portion 221, 222, and 223, respectively, of the fiber deflecting elements 211, 212 and 213, wherein the surface portions 221, 222, and 223 each at least partially form an outer surface of the connecting portion 210. The surface portions 221, 222 and 223 each extend at an angle of approximately 45°, in variations between 20° and 60°, out of the direction of the portions of the long fibers 201a, 202a and 203a running towards the connecting portion 210. These portions are shown to the left of the connecting portion 210 in FIG. 1. The long fibers 201a and 202a additionally run with a portion at the adjacent fiber deflecting elements 212 and 213, respectively, wherein the portions of the long fibers 201 and 202 change direction at the fiber deflecting elements 212 and 213, respectively. After the change in direction, they run along the surfaces 221 and 222 of the fiber deflecting elements 211 and 212, respectively. Due to the change in fiber direction, the outer surfaces 221, 222 and 223 of the fiber deflecting elements 211, 212 and 213, respectively, can be understood as fiber deflecting portions for the fibers. With respect to the long fibers 201a and 202a, due to the curved surfaces along which the fibers 201a and 202a run, the adjacent fiber deflecting elements 212 and 213 also fulfil the function of a fiber deflecting portion. Preferably, in the cross-section shown, the connecting portion 210 comprises three fiber deflecting elements 211, 212 and 213, as these provide sufficient force transmission for many cases. However, the number may also differ.

The long fibers 201a, 202a and 203a and correspondingly the portions of the long fibers 201, 202 and 203 consist of ⅓ longitudinal threads and ⅔ circumferential layers.

The fiber deflecting elements 211, 212 and 213 have protruding tips 231, 232 and 233 respectively in the direction of the connecting device 260. In this embodiment, the long fibers 201a, 202a and 203a extend maximally to the tips 231, 232 and 233, respectively. The long fibers 201a, 202a, 203a do not significantly change direction again after being deflected onto the fiber deflecting elements 211, 212 and 213, respectively. The surfaces 221, 222 or 223 of the fiber deflecting elements 211, 212 or 213, along which the long fibers 201a, 202a and 203a run, respectively, are at least approximately planar at least in a portion reaching into the vicinity of the tips 231, 232 and 233. These planar surfaces 221, 222 and 223 each merge, on the other side of the tips 231, 232 and 233 respectively and after a deflection of preferably 90°, into further surfaces 241, 242 and 243 respectively, each running from the tips 231, 232 and 233 respectively towards the interior of the connecting portion 210. At the end of each of these surfaces 241, 242 and 243 there are notches 251, 252 and 253, respectively, after which the outer surface of the connecting portion 210 continues in the next fiber deflecting element, unless it is the last fiber deflecting element 211. The two surfaces that contact at a tip 231, 232 or 233 form a V-shaped depression as shown in FIG. 1. Preferably, the two surfaces form the legs of an equilateral triangle. The long fibers 201a, 202a and 203a are preferably embedded in the outer surface of the fiber deflecting elements 211, 212 and 213, respectively. The fiber deflecting elements 211, 212 and 213 are each made of fiber composite material, wherein the fibers in the fiber deflecting elements 211, 212 and 213 run at least approximately at right angles to the viewing plane. In the case in which the connecting portion is tubular, tensile or compressive forces on the connecting portion are converted into circumferential forces in the fibers of the fiber deflecting elements 211, 212 or 213, which are absorbed as longitudinal stresses. In this way, the forces introduced can be well absorbed. This is made possible by the fact that, with respect to tension in the long fibers 201a, 202a and 203a, the surfaces 221, 222 and 223 with the long fibers 201a, 202a, 203a are arranged obliquely to the direction of introduction of force into the connecting portion 210. The same applies similarly to the surfaces 241, 242 and 243, respectively, with respect to the surfaces opposite the tips 231, 232 and 233, respectively, which are pressed against the connecting device 260 when pressure is introduced into the connecting portion 210. The pressure is also converted into circumferential forces by the oblique arrangement of the surfaces 241, 242 and 243 respectively, which are absorbed as tensile forces by the fiber deflecting elements 211, 212 and 213, respectively. This effect is achieved particularly well if the surfaces 221, 222, 223, 241, 242 or 243 are arranged obliquely to the direction of force introduction as just described. The fiber deflecting elements 211, 212 and 213 preferably have the same cross-section. The fiber deflecting elements 211, 212 and 213 can be embodied as independent fiber deflecting elements 211, 212 and 213. Alternatively, the fiber deflecting elements 211, 212 and 213 can be embodied as a helical, coherent fiber deflecting element 218. The connecting portion is then tubular. In this case, the surfaces 221, 222, 223, 241, 242 and 243, and the tips 231, 232 and 233 result in a thread-like outer or inner surface of the connecting portion 210. The fiber deflecting elements 211, 212 and 213 are arranged one behind the other along a straight line in the cross-section shown in FIG. 1.

The connecting device 260 comprises a carrier structure 261 to which there is secured an engagement portion 262 which is complementary in shape to the outer surface facing the connecting device 260. The portions of the engagement portion 262 facing the planar surfaces 221, 222, 223, 241, 242 and 243 of the connecting portion 210 are also planar and embodied with the same slope relative to the direction in which force is introduced. In this way, a form fit is achieved in the state in which the connecting portion 210 is secured to the connecting device 260. The connecting device 260 is tapered towards its free end. The side of the carrier structure 261 facing away from the connecting portion 210 is beveled here to form the taper.

Preferably, the connecting portion 210 and the connecting device 260 are embodied as separate elements without an integrally bonded connection. In the case of a transmission of torsional forces, however, it may be expedient to adhesively bond the connecting portion 210 to the connecting device 260. Preferably, at least one fiber layer relative to the connecting portion 210 is then embodied as a +45° layer. If the fiber deflecting element 218 is helical and there is a thread-like connection between the connecting portion 210 and the connecting device 260, torque can be transmitted in the tightening direction of the thread in a position against a threaded stop without the need for adhesive bonding.

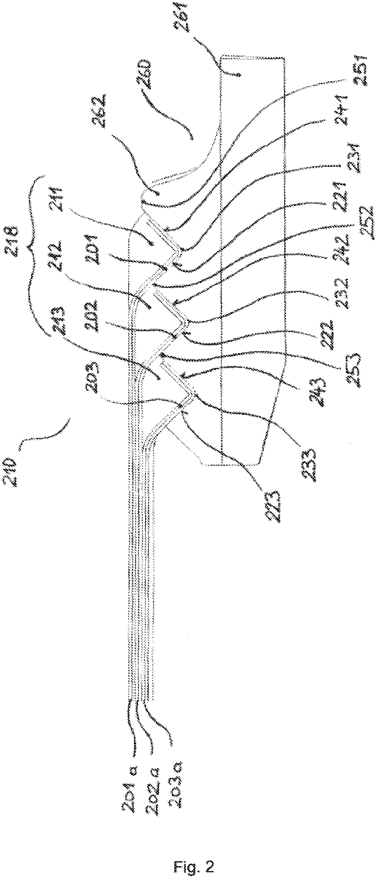

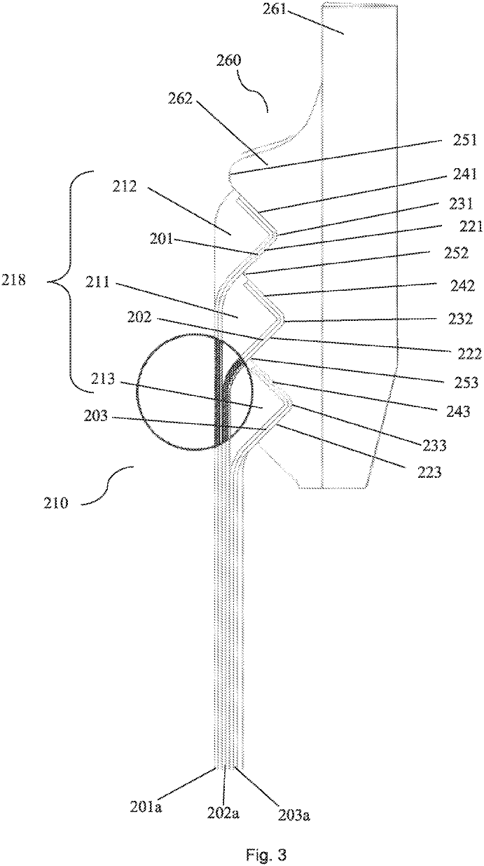

FIGS. 2 and 3 show a second embodiment in a cross-sectional view. The second embodiment corresponds for the most part to the first embodiment. Identical features are designated with the same reference characters. In the following, only the differences between the first and the second embodiment are discussed.

The second embodiment differs from the first embodiment in that the long fibers 201a, 202a and 203a extend beyond the tips 231, 232 and 233, respectively, and continue in the sloping, planar surfaces 241, 242 and 243, respectively. They are embedded in these surfaces 241, 242 and 243, respectively. They end at the end of the surfaces 241, 242 and 243, respectively, in the direction of the notches 251, 252 and 253, respectively, or the vicinity thereof. Compared to the first embodiment, there is the additional advantage that the long fibers 201a, 202a and 203a are more firmly connected to the fiber deflecting elements 211, 212 and 213, respectively. Furthermore, the additional fibers make the surfaces 241, 242 or 243 stronger and able to transmit higher compressive forces to the connecting device 260.

As can be seen in the detail in FIG. 3, the long fibers 201a, 202a and 203a and correspondingly the portions of the long fibers 201, 202 and 203 consist of ⅓ longitudinal threads and ⅔ circumferential layers. The circumferential layers also extend here beyond the tips 231, 232 and 233, respectively. In a tubular configuration of the connecting portion 210, the circumferential layers extend completely around the cylindrical portion of the connecting device 260.

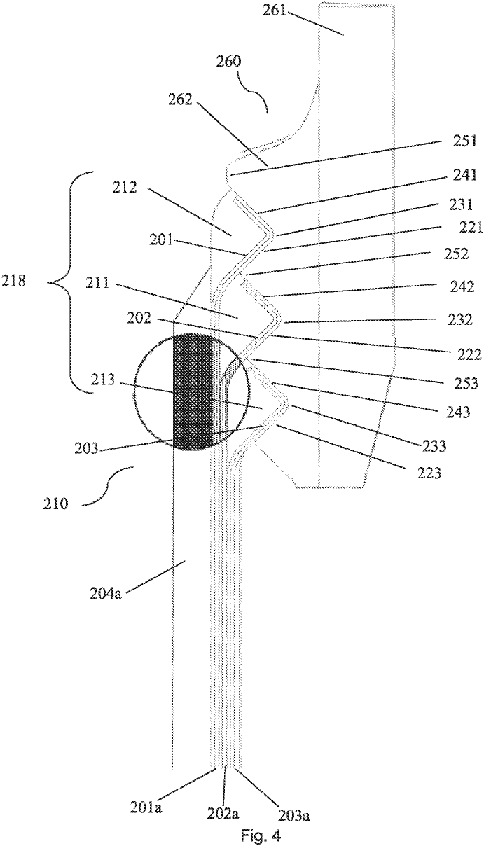

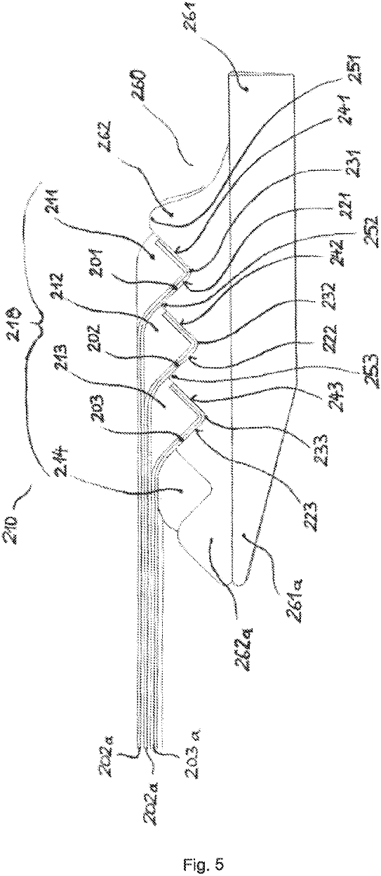

FIG. 4 shows a third embodiment of the connecting portion 210 and the connecting device 260 in a cross-sectional view. The third embodiment corresponds for the most part to the second embodiment. Identical features are designated with identical reference characters. In the following, only the differences between the second and third embodiments will be discussed.

The third embodiment differs from the second embodiment in that it comprises long fibers 201a, 202a and 203a and, correspondingly, the portions of the long fibers 201, 202 and 203 consist entirely of longitudinal threads. There is an additional long fiber 204a, which wraps completely around the long fibers 201a, 202a and 203a, arranged on the outer surface of the connecting portion 210. This long fiber 204a consists entirely of circumferential layers. In this way, the circumferential layers are separated from the longitudinal layers.

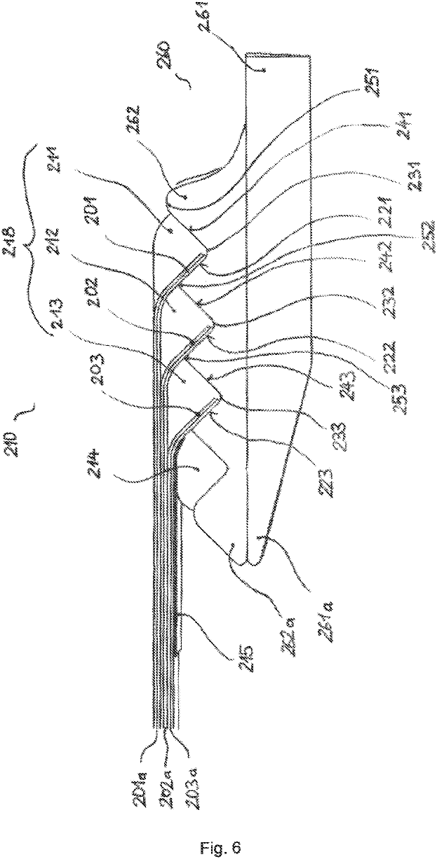

FIG. 6 shows a fourth embodiment of the connecting portion 210 and the connecting device 260 in a cross-sectional view. The fourth embodiment corresponds for the most part to the second embodiment. Identical features are designated with identical reference characters. In the following, only the differences between the second and third embodiments will be discussed.

The fourth embodiment differs from the second embodiment by an additional further fiber deflecting element 214 on the connecting portion 210. Said additional further fiber deflecting element is arranged in continuation of the row of fiber deflecting elements 211, 212 and 213 in a direction away from the free end of the connecting portion 210. However, it differs from the other fiber deflecting elements 211, 212 and 213 in that it does not have embedded therein long fibers 201a, 202a and 203a with which the connecting portion 210 is connected, for example, to a component not explicitly shown. However, in the case in which the connecting portion 210 is tubular, fibers are embedded in the circumferential direction in the fiber deflecting element 214 to allow the fiber deflecting element to better absorb forces from the deflection of the long fibers 203a. The forces from the long fibers are converted into circumferential forces by the ring shape. This increases the strength of the connection.

Another difference is that in the fourth embodiment the connecting device 260 is elongated in the direction of its free end. The carrier extension portion 261a, around which the carrier structure 261 is extended, continues the taper shown in FIGS. 1 and 2 at the free end of the carrier structure 261. The carrier extension portion 261a bears, in the direction of the connecting portion 210, against a similarly additional abutment portion 262a of the engagement portion 262 for the additional fiber deflecting element 214. The additional abutment portion 262a has a sloping, planar surface which, in the secured state, bears against a similarly sloping plane of the additional fiber deflecting element 214. This is similar to the surfaces of the connecting device that are complementary in shape to the force-transmitting surfaces 221, 241, 222, 242, 223, 243 of the connecting portion 210. The elongation of the connecting device 260, its continued taper, and the additional fiber deflecting element 214 without embedded long fibers for the introduction of force into the connecting portion create a supportive, yet somewhat yielding transition between the force-introducing long fibers 201a, 202a and 203a and the force-transmitting remaining connecting portion 210. This homogenizes the load on the long fibers 203a.

FIG. 6 shows a fifth embodiment of the connecting portion in a cross-sectional illustration. The fifth embodiment corresponds for the most part to the fourth embodiment. Identical features are designated with identical reference characters. In the following, only the differences between the fifth and the fourth embodiment are discussed.

The fifth embodiment differs from the fourth embodiment in that the connecting portion 210 additionally has a support layer 215 between the fiber deflecting element 214 and the fiber layer 203a. This support layer 215 extends away from the free end of the connecting portion 210 beyond the additional fiber deflecting element 214. The support layer 215 further homogenizes the tension in the connecting portion 210, so that said connecting portion has a greater load-bearing capability at only a slightly higher material cost for the support layer 215.

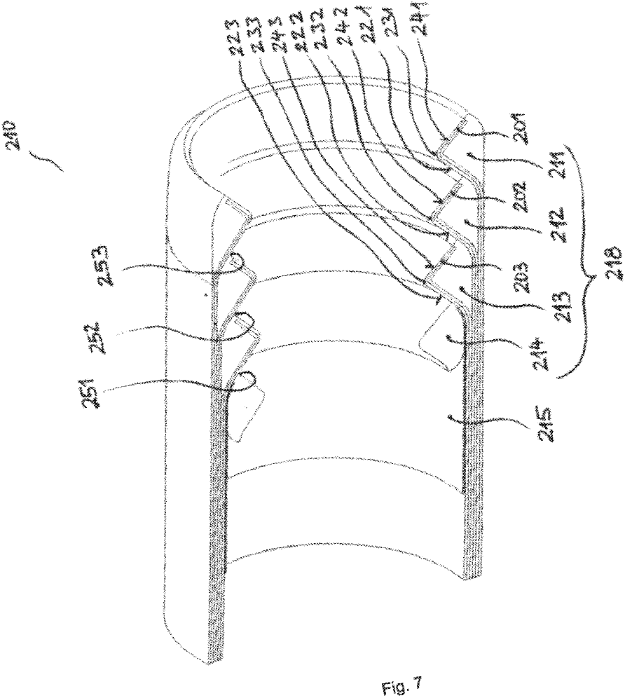

In addition, the fifth embodiment differs from the fourth embodiment in that the long fibers 201a, 202a and 203a are not continued beyond the tips 231, 232 and 233, respectively, into the second sloping surfaces 241, 242 and 243, respectively, as in the first embodiment shown in FIG. 1. However, as an alternative to the fourth embodiment, the long fibers 201a, 202a and 203a can also be continued into the surfaces 241, 242 and 243, respectively, as shown in FIG. 7 in a sixth embodiment, which provides advantages of this difference, as indicated above with reference to FIG. 2.

FIG. 7 shows the sixth embodiment of the connecting portion 210 with a tubular configuration in a perspective sectional view. The reference characters of the same features are identical to those in the other figures.

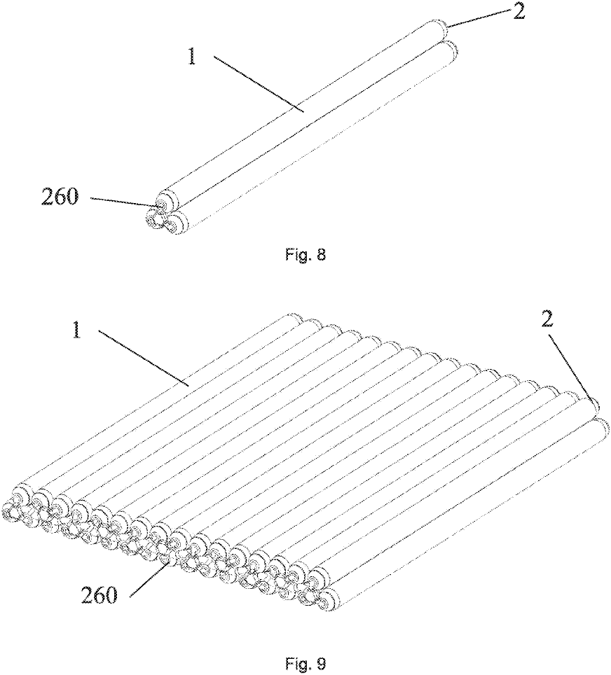

FIG. 8 shows an arrangement of three pressure tanks 1. The pressure tanks 1 are tubular fiber composite material structures which are connected at one end by connecting devices and have a dome cap 2 at their other end.

FIG. 9 shows an arrangement of thirty-three pressure tanks 1. The pressure tanks 1 are tubular fiber composite material structures which are connected at one end by connecting devices and have a dome cap 2 at their other end. The pressure tanks 1 are grouped into sub-assemblies of three pressure tanks 1 each. Each of these sub-assemblies is connected to the other sub-assemblies.

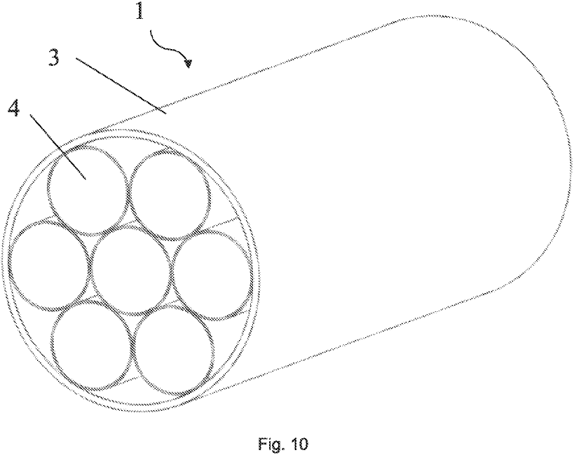

FIG. 10 shows a pressure tank 1 for cryogenic applications. The pressure tank 1 is configured as a double-walled tank with seven cryogenic inner tanks 4, for example for liquid H₂, and gaseous H₂ in the outer tank 3. If the cryogenic content, for example H₂, becomes warmer than 20 K, part of the content must be blown off in order to cool down the remaining content. This blow-off can take place from the inner tanks 4 into the outer tank 3 and continue to be available there as gaseous H₂.

1. A use of a fiber composite material connecting portion (210) to connect a tubular fiber composite material structure to a connecting device (260), wherein the fiber composite material structure has more circumferential layers than longitudinal threads, wherein the connecting portion (210) has at least one fiber deflecting element (211, 212, 213) in its interior, wherein the course of the long fibers (201a, 202a, 203a) from the fiber composite component follows the shape of a fiber deflecting portion of a fiber deflecting element (211, 212, 213) so that the fiber direction thereof is deflected at the fiber deflecting portion, and wherein the long fibers (201a, 202a, 203a) do not completely loop around the fiber deflecting elements (211, 212, 213) with which they are associated respectively, wherein the fiber deflecting elements (211, 212, 213) comprise fiber composite material, and wherein no firm connection is present between the tubular fiber composite material structure and the connecting device (260), for a pressure tank (1).

2. The use according to claim 1, wherein the fiber composite material of the fiber deflecting elements (211, 212, 213) comprises mainly circumferential layers.

3. The use according to claim 1, wherein the connecting device (260) comprises a dome cap (2).

4. The use according to claim 1, wherein the fiber composite material structure comprises a liner.

5. The use according to claim 1, wherein a plurality of tubular fiber composite material structures are interconnected via the connecting devices (260).

6. The use according to claim 1, wherein a plurality of tubular fiber composite material structures are interconnected and combined in the form of sub-assemblies.

7. The use according to claim 4, wherein the liner, depending on the pressure direction, is applied to the tubular fiber composite material structure inside or outside.

8. The use according to claim 4, wherein the liner serves as a core for the winding of the tubular fiber composite material structure.

9. A pressure tank (1) comprising:
a tubular fiber composite material structure;
a connecting device (260); and
a fiber composite material connecting portion (210) used to connect the tubular fiber composite material structure to the connecting device (260);
wherein the fiber composite material structure has more circumferential layers than longitudinal threads;
wherein the connecting portion (210) has at least one fiber deflecting element (211, 212, 213) in its interior;
wherein the course of the long fibers (201a, 202a, 203a) from the fiber composite component follows the shape of a fiber deflecting portion of a fiber deflecting element (211, 212, 213) so that the fiber direction thereof is deflected at the fiber deflecting portion;
wherein the long fibers (201a, 202a, 203a) do not completely loop around the fiber deflecting elements (211, 212, 213) with which they are associated respectively;
wherein the fiber deflecting elements (211, 212, 213) comprise fiber composite material; and
wherein no firm connection is present between the tubular fiber composite material structure and the connecting device (260).

10. The pressure tank (1) according to claim 9, wherein the fiber composite material of the fiber deflecting elements (211, 212, 213) comprises mainly circumferential layers.

11. The pressure tank (1) according to claim 9, wherein the connecting device (260) comprises a dome cap (2).

12. The pressure tank (1) according to claim 9, wherein the fiber composite material structure comprises a liner.

13. The pressure tank (1) according to claim 12, wherein the liner, depending on the pressure direction, is applied to the tubular fiber composite material structure inside or outside.

14. The pressure tank (1) according to claim 12, wherein the liner serves as a core for the winding of the tubular fiber composite material structure.

15. The pressure tank (1) according to claim 9, wherein a plurality of tubular fiber composite material structures are interconnected via the connecting devices (260).

16. The pressure tank (1) according to claim 9, wherein a plurality of tubular fiber composite material structures are interconnected and combined in the form of sub-assemblies.
